(19) United States
(12) Patent Application Publication
(10) Pub. No.: US 2006/0288042 A1
(43) Pub. Date: Dec. 21, 2006

(54) SYSTEM AND METHOD FOR GENERATING A PLAY-LIST

(76) Inventors: Kuan-Hong Hsieh, Guangdong (CN); Xiao-Guang Li, Guangdong (CN); Zai-An Pan, Guangdong (CN); Bing Li, Guangdong (CN)

Correspondence Address: NORTH AMERICA INTELLECTUAL PROPERTY CORPORATION, P.O. BOX 506, MERRIFIELD, VA, 22116, US

(21) Appl. No.: 11/308,697

(22) Filed: Apr. 24, 2006

(30) Foreign Application Priority Data
Jun. 17, 2005 (CN) 200510035413.4

(51) Int. Cl. G06F 17/00

(52) U.S. Cl. 707/104.1

(57) ABSTRACT

The present invention relates to a method for generating a play-list of media files, each of the media files includes a tag for holding relative information about the media files. The method includes the steps of: setting a play count field in the tag for storing a play count of the media file; setting a weight table for storing different play counts and corresponding weight values; updating the play count in the play count field of each media file during the course of the media files being played; obtaining the corresponding weight values of each media file from the weight table according to the play count thereof; and generating the play-list of the media files according to the weight values thereof. The present invention also provides a system for generating the play-list. The present invention makes the play-list more suitable for the user's favors.

### FIELD OF THE INVENTION

The present invention relates to a system and method for generating a media play-list, especially to a system and method for generating a play-list according to the number of times a user selects the media file to be played.

### DESCRIPTION OF RELATED ART

The continuous development of new digital technology has helped made digital devices such as digital audio, digital picture, and other digital medias become popular among people. Media can be stored digitally in various data storage medium such as a hard disk, a compact disc (CD), and a network server. These data storage medium can then be used with portable devices such as a personal digital assistant (PDA), a media player, and/or an electronic-book reader (e-book). A current standard CD can store up to 140 average sized MPEG layer three (MP3) media files, whereas a media player with a data storage medium of 10 Gigabytes can store up to 2000 MP3 files. The cost of data storage medium has continued to decrease, allowing the average person to more easily acquire more data storage capacity. Currently, a personal computer has a standard data storage capacity of 80 Gigabytes that can easily store up to 160,000 pieces of average sized MP3 files. As users continuously acquire their favorite media files, it is important that users can also quickly identify and select a desired media file from a humongous pool of stored files.

Most media players currently have an option to group and select media files by the media file's tag contents. Usually, the media file's title, artist, album, and genre identity are stored by the tags to allow media players to automatically search and categorize the files. A media file management program further allows users to select a combination of media files into a play-list file. The saved play-list is essentially a list of shortcuts (pointer to the directory path) of the media files stored within, and can be used by the media player instead of manually searching and selecting every desired media files each time the media player is executed. Each play-list can then be categorically stored by name. However, users are still required to remember the directory path where each play-list is stored. As a user creates more and more play-lists, remembering a desired play-list may not be easy, furthermore, skipping over an unwanted media file while playing a play-list still has to be done manually.

In order to solve the problems mentioned, there is a method available in the market in selecting favorite media files to generate a play-list. For example, U.S. Pat. No. 6,987,221 issued on Jan. 17, 2006 and entitled “AUTO PLAYLIST GENERATION WITH MULTIPLE SEED SONGS” provides a method for generating a play-list automatically. The method includes steps of: selecting one or more feed media files, the feed media files include desired media files and undesired media files; wherein the user can set a weight on each seed media file representing the importance level of each seed media file. Afterwards, the method compares each media file with each seed media file such that a media file can be analyzed and identified into a user defined preferred play-list. The play-list further allows manual edits by the user.

However, the above mentioned method requires manual inputs on the weight attributes on multiple seed files before the method can run comparison tests on each media files. These manual operations may be annoying and time consuming with no guarantee that the resulting selected media files would be tailored to a user's listening preferences.

Therefore, a heretofore unaddressed need exists in the industry to overcome the aforementioned deficiencies and inadequacies.

### SUMMARY OF INVENTION

In order to solve said problems, the present invention provides a method and system for setting a weight value on each media file according to the play count of the media file, and then generating a play-list according to weight values of the media files. The present invention makes the play-list more suitable to the user's listening preferences.

The method for generating a play-list of media files, each of the media files includes a tag for holding relative information about the media files. The method includes the steps of: setting a play count field in the tag for storing a play count of the media file; setting a weight table for storing different play counts and corresponding weight values; updating the play count in the play count field of each media file during the course of the media files being played; obtaining the corresponding weight values of each media file from the weight table according to the play count thereof; and generating the play-list of the media files according to the weight values thereof.

The system for generating a play-list of media files, each of the media files includes a tag for holding relative information about the media files. The system includes a data storage unit, an input unit, a control unit and a file management unit. The data storage unit stores a plurality of media files and a weight table. The tag of each media file includes a play count field for storing a play count of the media file, and the weight table stores different play counts and corresponding weight values. The input unit generates commands in response to operations of a user. The commands include a command for generating a play-list. The control unit identifies the commands and executes corresponding control commands. The file management unit, under the control of the control unit, updates the play count in the play count field of each media file during the course of the media files being played, obtains the corresponding weight values of each media file from the weight table according to the play count thereof, and generates the play-list of the media files according to the weight values thereof.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a schematic diagram of a user-interface of an media player such as a MP3 player in accordance with a preferred embodiment of the present invention;

FIG. 2 is a block diagram of hardware infrastructure of the media player of FIG. 1;

FIG. 3 (FIG. 3A and FIG. 3B) is a flowchart of a preferred method for generating a play-list and updating the play count in the play count field of each media file listed on the play-list in the media player of FIG. 2; and

FIG. 4 is a schematic diagram representing a relationship between a play count and a weight value.

### DETAILED DESCRIPTION

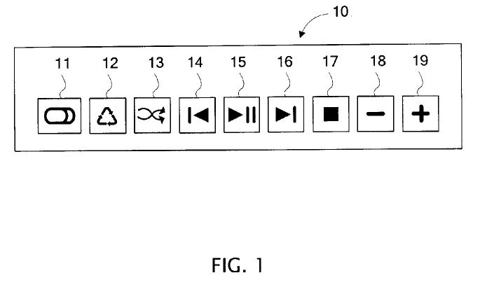

FIG. 1 is a schematic diagram of a user-interface of an media player such as a MP3 player in accordance with a preferred embodiment of the present invention. The media player 10 is user-controllable to skip forward (e.g., to next item), play a media file, pause a playing media file, skip backward (e.g., to previous item), activate/deactivate the media player, adjust the volume output of the media player, and the like. Accordingly, the media player 10 provides a user-interface for selecting these functions. The user-interface sets a plurality of buttons thereon, such as a skip forward button 14, a play/pause button 15, a skip backward button 16, a stop/power button 17, a decrease volume button 18, and an increase volume button 19. The user-interface further sets a play in order button 12 for playing selected media files in a predefined sequential order, and a random play button 13 for playing the media files randomly. Moreover, the user-interface includes a locked button 11 for locking the buttons 12 to 19 thereby disabling the button functions therewith.

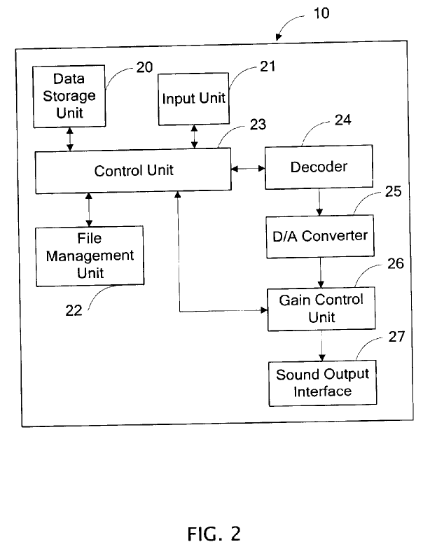

FIG. 2 is a block diagram hardware infrastructure of the media player 10 of FIG. 1. The media player 10 includes a data storage unit 20, an input unit 21, a file management unit 22, a control unit 23, a decoder 24, a digital/analog converter 25, a gain control unit 26, and a sound output interface 27. The data storage unit 20 stores a plurality of media files, a weight table, a default play-list, and one or more favorite index tables for indicating favorite media files of a user. Each of the media files is composed of a plurality of frames; a frame can be viewed as a small segment of the media. Furthermore, each media file includes a tag for holding relative information of the media file. The relative information includes a play count (i.e. the number of times the digital media file is selected to play), a loading time, a frame length, and so on. Accordingly, the tag includes a play count field, a loading time field, a frame length field, etc., to store corresponding basic information. The weight table (described in detailed below) stores the play counts and their corresponding weight values. The weight values would indicate the user's preference level on a given media file. In addition, the data storage unit 20 can be a flash storage, a hard disk driver, and the like.

The input unit 21 includes a plurality of buttons (i.e., 11 to 19), thereby forming the user-interface of a preferred media player (as shown in FIG. 1) to compute commands in response to operational inputs. The control unit 23 receives and identifies the commands from the input unit 21, and generates corresponding control commands to control the data storage unit 20, the file management unit 22, the gain control unit 26, and the like. Wherein, the control commands include a control command for generating a play-list, and a control command for skipping the media file being played (namely a skipping control command).

When a control command is issued by the control unit 23, the file management unit 22 obtains the play count of each media file from the play count field, obtains the weight value corresponding to the play count from the weight table, stores the weight values of each media file in a temporary file, generates a play-list of the media files according to the weight values in the temporary file, stores the play-list in the data storage unit 20, plays the media files listed on the play-list, and updates the play count in the play count field of each media file being played. In addition, the media files listed on the play-list may be from digital media files stored in the data storage unit 20, or may be from favorite digital media files indicated in the index table stored in the data storage unit 20.

The decoder 24 decodes the media file from a coded digital format into a readable digital format to be played. The digital/analog converter 25 converts the decoded digital media file to analog media signals. The gain control unit 26 amplifies the analog media signals under the control of the control unit 23. The sound output interface 27 outputs the amplified analog media signals to an earphone or a speaker (not shown).

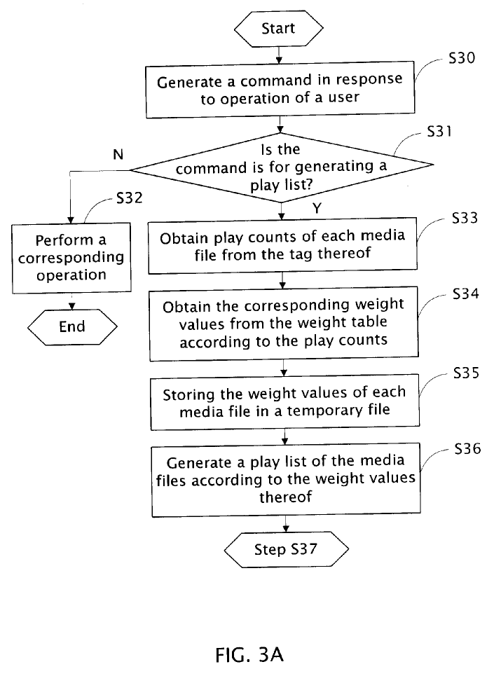

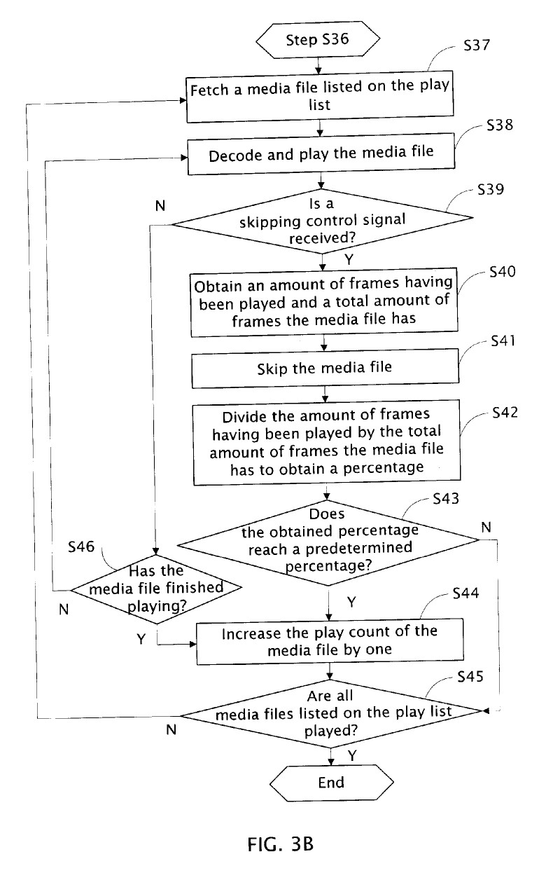

FIG. 3 (including FIG. 3A and FIG. 3B) is a flowchart of a preferred method for generating a play-list and updating the play count in the play count field of each media file listed on the play-list in the media player of FIG. 2. In a power-off state of the medial player 10, a user selects the stop/power button 17 to activate the media player 10. In step S30, the input unit 21 generates a command in response to an input selection of the user, and sends the command to the control unit 23. In step S31, the control unit 23 determines whether an inputted command is for updating a default play-list, namely generating a new play-list. If the command is not for generating a play-list, in step S32, the control unit 23 controls a corresponding unit to perform a corresponding operation according to the command, and the procedure is finished. If the command is for generating a play-list, in step S33, the file management unit 22 obtains the play count of each media file from the tag thereof. The play count can be a total play count, an average play count per week, an average play count per month, and the like. The total play count indicates total play times after the media file is loaded in the media player 10. Correspondingly, the average play count per week/month indicates average play times per week/month after the media file is loaded in the media player 10.

In step S34, referring to FIG. 5, the file management unit 22 obtains the corresponding weight value from the weight table according to the play count. In step S35, the file management unit 22 stores the weight values of each media file in a temporary file in the data storage unit 20. In step S36, the file management unit 22 generates the play-list of the media files according to the weight values thereof. For example, the file management unit 22 rearranges all the media files stored in the data storage unit 20 according to the weight values, thereby generating a play-list therefrom. That is, the file management unit 22 orderly rearranges the media files according to the weight values, or calls a random function, which employs the weight values of the media files as a parameter, to randomly rearrange the media files. I.e., the media files having the greater weight values would be listed on more front of the play-list.

Furthermore, the file management unit 22 may also directly select a plurality of media files each of which has a weight value being greater than a predetermined value, thereby generating another play-list therefrom. The file management unit 22 may also rearrange all the media files based on the weight values in descending order, and then selects a predetermined amount of media files on the top of the ordered list, thereby generating another play-list therefrom.

In step S37, the file management unit 22 fetches a media files listed on the play-list. In step S38, the decoder 24 decodes the media file from a coded digital form to a decoded digital form, the digital/analog converter 25 converts the digital media signals to analog media signals, the gain control unit 26 amplifies the analog media signals under the control of the control unit 23, the sound output interface 27 outputs the amplified analog media signals to an earphone or a speaker (not shown). During the course of playing the media file, in step S39, the file management unit 22 determines whether a skipping control command is received from the control unit 23. If the skipping control command is received, in step S40, the file management unit 22 obtains an amount of frames having been played, and a total amount of frames the media file has from the frame field thereof. In step S41, the file management unit 22 skips the media file being played. In step S42, the file management unit 22 divides the amount of frames having been played by the total amount of frames the media file has to obtain a percentage.

In step S43, the file management unit 22 determines whether the obtained percentage reaching a predetermined percentage, such as seventy-five percent. The predetermined percentage indicates the media file almost has been played over. If the obtained percentage is less than the predetermined percentage, the file management unit 22 maintains the play count of the media file as the same as that of before playing, and the procedure goes to step S45. If the obtained percentage reaches the predetermined percentage, in step S44, the file management unit 22 increases the play count of the media file by one and stores the increased play count in the tag of the media file. In step S45, the file management unit 22 determines whether all media files listed on the play-list are played. If all the media files listed on the play-list are played, the procedure is finished. If any media file listed on the play-list is not played, the procedure goes to step S37 to fetch a next media file to play.

In step S39, If the skipping control command is not received, in step S46, the file management unit 22 determines whether the media file has finished playing. If the media file has finished playing, the procedure goes to step S44. If the media file has not finished playing, the procedure goes to the step S38 to continually decode and play the media file. During the course of playing a media file listed on the play-list, if the control unit 23 receives a stop command from the input unit 21, and then controls the file management unit 22 to stop playing the media file, and the procedure is finished.

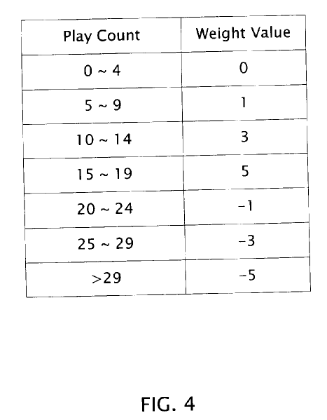

FIG. 4 is a schematic diagram representing a relationship between a play count and a weight value. For simplicity, in such case, when the play count is between 0 and 4, the corresponding weight value is 0; when the play count is between 5 and 9, the corresponding weight value is 1; when the play count is between 24 and 29, corresponding weight value is −3; when the play count exceeds 29, corresponding weight value is −5. However, the relationship between the play count and weight value may vary. That is, the relationship between the play count and weight value can be set and adjusted.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A method for generating a play-list of media files, each of the media files comprising a tag for holding relative information about the media file, the method comprising the steps of:
setting a play count field in the tag for storing a play count of the media file;
setting a weight table for storing different play counts and corresponding weight values;
updating the play count in the play count field of each media file during the course of the media files being played;
receiving a control command for generating a play-list;
obtaining the corresponding weight values of each media file from the weight table according to the play count thereof in response to the control command; and
generating the play-list of the media files according to the weight values thereof.

2. The method for generating a play-list according to claim 1, wherein the play count is selected from the group consisting of a total play count, an average play count per week, and an average play count per month.

3. The method for generating a play-list according to claim 1, wherein the step of generating the play-list of the media files further comprises: rearranging all the media files according to the weight values, thereby generating the play-list therefrom.

4. The method for generating a play-list according to claim 1, wherein the step of generating the play-list of the media files further comprises: selecting one or more media files each of which has a weight value being greater than a predetermined value, thereby generating the play-list therefrom.

5. The method for generating a play-list according to claim 1, wherein the step of generating the play-list of the media files further comprises: rearranging all the media files based on the weight values in descending order, selecting a predetermined amount of media files on the top of the ordered list, thereby generating another play-list therefrom.

6. The method for generating a play-list according to claim 1, wherein the step of updating the play count in the play count field of the media file being played further comprises:
obtaining an amount of frames having been played and a total amount of frames the media file has;
dividing the amount of frames having been played by the total amount of frames of the media file to obtain a percentage; decreasing the play count of the media file by one when the percentage reaching a predetermined percentage.

7. A system for generating a play-list of media files, each of the media files comprising a tag for holding relative information about the media files, the system comprising:
a data storage unit, for storing the media files and a weight table, wherein the tag of each media file comprises a play count field for storing a play count of the media file, and the weight table stores different play counts and corresponding weight values;
an input unit for generating commands in response to operations of a user;
a control unit for identifying the commands and performing corresponding control commands, wherein the control commands comprise a play-list generation control command; and
a file management unit, under the control of the control unit, for updating the play count in the play count field of each media file during the course of the media files being played, receiving the play-list generation control command; obtaining the corresponding weight values of each media file from the weight table according to the play count thereof in response to the play-list generation control command, and generating the play-list of the media files according to the weight values thereof.

8. The system for generating a play-list according to claim 7, wherein the play count is selected from the group consisting of a total play count, an average play count per week, and an average play count per month.

9. The system for generating a play-list according to claim 7, wherein the file management unit further rearranges all the media files stored in the data storage unit according to the weight values, thereby generating the play-list therefrom.

10. The system for generating a play-list according to claim 7, wherein the file management unit further selects one or more media files each of which has a weight value being greater than a predetermined value, thereby generating the play-list therefrom.

11. The system for generating a play-list according to claim 7, wherein the file management unit further rearranges all the media files based on the weight values in descending order, selects a predetermined amount of media files on the top of the ordered list, thereby generates another play-list therefrom.

12. The system for generating a play-list according to claim 7, wherein the file management unit further obtains an amount of frames having been played and a total amount of frames the media file has; divides the amount of frames having been played by the total amount of frames of the media file to obtain a percentage; decreases the play count of the media file by one when the percentage reaching a predetermined percentage.
